(19) United States
(12) Patent Application Publication
(10) Pub. No.: US 2026/0257742 A1
(43) Pub. Date: Sep. 3, 2026

(54) SADDLED VEHICLE

(71) Applicant: HONDA MOTOR CO., LTD., Tokyo (JP)

(72) Inventors: Koichiro Sugimoto, Minato-ku, Tokyo (JP); Yosuke Tsuchiya, Minato-ku, Tokyo (JP); Yusuke Kimura, Minato-ku, Tokyo (JP); Toya Tsukagoshi, Minato-ku, Tokyo (JP); Yohei Mitsui, Minato-ku, Tokyo (JP)

(21) Appl. No.: 19/164,951

(22) PCT Filed: Mar. 1, 2024
(86) PCT No.: PCT/JP2024/007886

§ 371 Date: Sep. 12, 2025

(30) Foreign Application Priority Data
Mar. 31, 2023 (JP) 2023-059381

(51) Int. Cl. B62J 6/20; B62J 6/022; F21S 41/36

(52) U.S. Cl. CPC B62J 6/20; B62J 6/022; F21S 41/36

(57) ABSTRACT

To allow others to recognize a vehicle even if there is an obstacle to the side of the vehicle. In a saddle-ride vehicle including a lighting device (41), the lighting device (41) emits predetermined light capable of providing a higher brightness than headlight light of the vehicle at a predetermined position spaced away from the vehicle, the predetermined light being emitted from a position forward of the center of the vehicle in a front-rear direction.

### TECHNICAL FIELD

The present invention relates to a saddle-ride vehicle.

### BACKGROUND ART

Some vehicles are equipped, in a headlight unit, with an auxiliary lamp that illuminates a region other than an illumination region of a headlight. For example, in a vehicle described in Patent Literature 1, a large deflection lamp, a middle deflection lamp and a large diffusion lamp are arranged in this order from the center of the vehicle to outside, and the large diffusion lamp is configured to illuminate a region in the vicinity of an own vehicle laterally from front to sides and further to rear, so that a driver can easily check pedestrians, bicycles and the like present in the vicinity of the own vehicle.

### CITATION LIST

### Patent Literature

Patent Literature 1: Japanese Patent Laid-Open No. 2010-111132

### SUMMARY OF INVENTION

### Technical Problem

However, a main object of such a conventional configuration is to allow a driver to check a pedestrian, a bicycle, and the like and the main object is not to allow the vehicle to be noticed by a driver of another vehicle or the pedestrian. In the conventional configuration, when there is an obstacle to the side of the vehicle, light may be blocked by the obstacle.

An object of the present invention, which has been made in view of the above-described circumstances, is to allow others to easily recognize a vehicle even if there is an obstacle to the side of the vehicle.

### Solution to Problem

This description includes all contents of Japanese Patent Application No. 2023-059381 filed on Mar. 31, 2023.

In a saddle-ride vehicle including a lighting device, the lighting device emits predetermined light capable of providing a higher brightness than headlight light of the vehicle at a predetermined position spaced away from the vehicle, the predetermined light being emitted from a position forward of the center of the vehicle in a front-rear direction.

### Advantageous Effect of Invention

Even if there is an obstacle to the side of a vehicle, the vehicle can be easily recognized by others.

### BRIEF DESCRIPTION OF DRAWINGS

FIG. 1 shows a side view of a saddle-ride vehicle according to an embodiment of the present invention.

FIG. 2 shows, from front, a state where a front surface cover is removed from a light unit.

FIG. 3 shows a left side view of a housing.

FIG. 4 shows a perspective view of the housing.

FIG. 5 schematically shows an example of a shape of a first opening.

FIG. 6 schematically shows another example of the shape of the first opening.

FIG. 7 schematically shows a pair of left and right light irradiators together with a peripheral configuration in vehicle top view.

FIG. 8 shows, from above, a traveling situation where vehicles travel.

FIG. 9 shows a vehicle together with another vehicle from above.

FIG. 10 shows a vehicle together with another vehicle from above.

FIG. 11 shows a situation where pedestrians exist on the left and right side forward of a traveling saddle-ride vehicle.

FIG. 12 schematically shows a pair of left and right light irradiators according to another embodiment together with a peripheral configuration in vehicle top view.

FIG. 13 is an explanatory view of a modification.

### DESCRIPTION OF EMBODIMENT

An embodiment of the present invention will be described below with reference to the drawings. Unless otherwise mentioned, directions including front-rear, left-right, and up-down mentioned in the description are the same as those directions relative to a vehicle body. Reference signs FR, UP, and LH shown in the drawings indicate a vehicle body front side, a vehicle body upper side, and a vehicle body left side, respectively.

### Embodiment

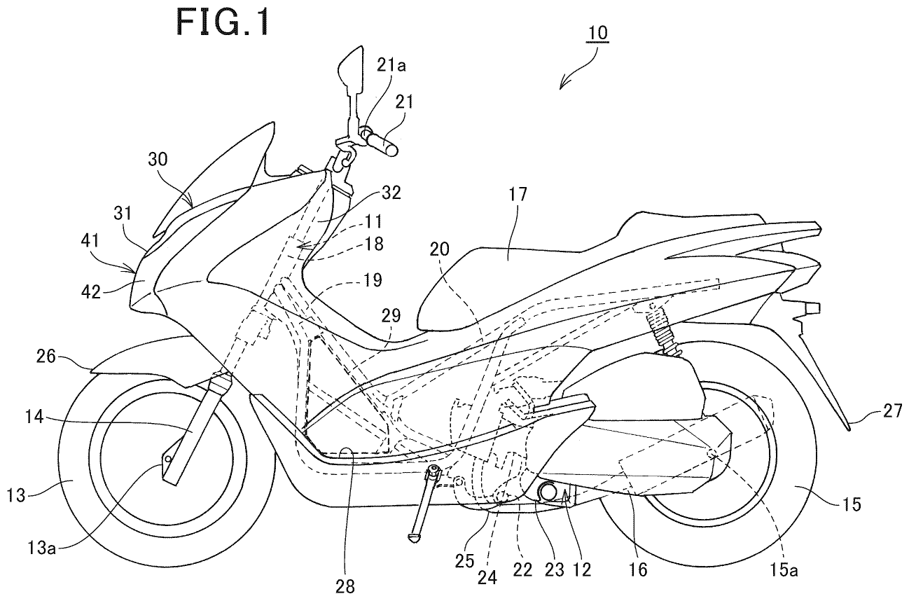

FIG. 1 is a side view of a saddle-ride vehicle 10 according to an embodiment of the present invention.

The saddle-ride vehicle 10 is a vehicle including a vehicle body frame 11, a power unit 12 supported on the vehicle body frame 11, a front fork 14 that supports a front wheel 13 in a steerable manner, a swing arm 16 that supports a rear wheel 15, and a seat 17 for a rider.

The saddle-ride vehicle 10 is a vehicle on which the rider sits astride the seat 17. The seat 17 is provided above a rear part of the vehicle body frame 11.

The vehicle body frame 11 includes a head pipe 18 provided at a front end portion of the vehicle body frame 11, a front frame 19 located on a rear side of the head pipe 18, and a rear frame 20 located on a rear side of the front frame 19. A front end portion of the front frame 19 is connected to the head pipe 18.

The seat 17 is supported on the rear frame 20.

The front fork 14 is supported on the head pipe 18 in such a manner that it can be steered left and right. The front wheel 13 is supported on an axle 13a provided at a lower end portion of the front fork 14. A handle 21 for steering that the rider grasps is mounted at an upper end portion of the front fork 14.

The swing arm 16 is supported on a pivot shaft 22 that is supported on the vehicle body frame 11. The pivot shaft 22 is a shaft extending horizontally in a vehicle width direction. The pivot shaft 22 is passed through a front end portion of the swing arm 16. The swing arm 16 swings up and down around the pivot shaft 22.

The rear wheel 15 is supported on an axle 15a provided at a rear end portion of the swing arm 16.

The power unit 12 is disposed between the front wheel 13 and the rear wheel 15 and supported on the vehicle body frame 11.

The power unit 12 is an internal combustion engine. The power unit 12 includes a crankcase 23 and a cylinder 24 that houses a reciprocating piston. An exhaust device 25 is connected to an exhaust port of the cylinder 24.

An output of the power unit 12 is transmitted to the rear wheel 15 through a drive power transmission member that connects the power unit 12 and the rear wheel 15 to each other.

The saddle-ride vehicle 10 further includes a front fender 26 that covers the front wheel 13 from above, a rear fender 27 that covers the rear wheel 15 from above, footrests 28 on which the rider places his or her feet, and a fuel tank 29 that stores fuel to be used by the power unit 12.

The front fender 26 is mounted on the front fork 14. The rear fender 27 and the footrests 28 are provided on a lower side relative to the seat 17. The fuel tank 29 is supported on the vehicle body frame 11.

The saddle-ride vehicle 10 includes a vehicle body cover 30 that covers the vehicle body. The vehicle body cover 30 includes a front cover 31 that covers a front part of the vehicle body from front and left and right sides, and an inner cover 32 that covers the front frame 19 from above. The front cover 31 has a cover shape that expands in a vehicle width direction and up-down direction as being rearward and is formed in a symmetrical shape with respect to a vehicle width center. A light unit 41 is attached to the front cover 31.

The light unit 41 is a unit constituting a part of a lighting device of the saddle-ride vehicle 10 and is also referred to as a headlight unit. The light unit 41 includes a front surface cover 42 that covers a front surface. The front surface cover 42 has a front surface formed in a shape continuous with the front surface of the front cover 31, that is, it is formed in an inclined shape that is rearward as being away from the vehicle width center in left-right and up-down directions. The front surface cover 42 includes an outer lens. Note that the light unit 41 is located forward of the center of the saddle-ride vehicle 10 in the vehicle front-rear direction, and more specifically, is located forward of a steering handlebar 21a and the vehicle body frame 11.

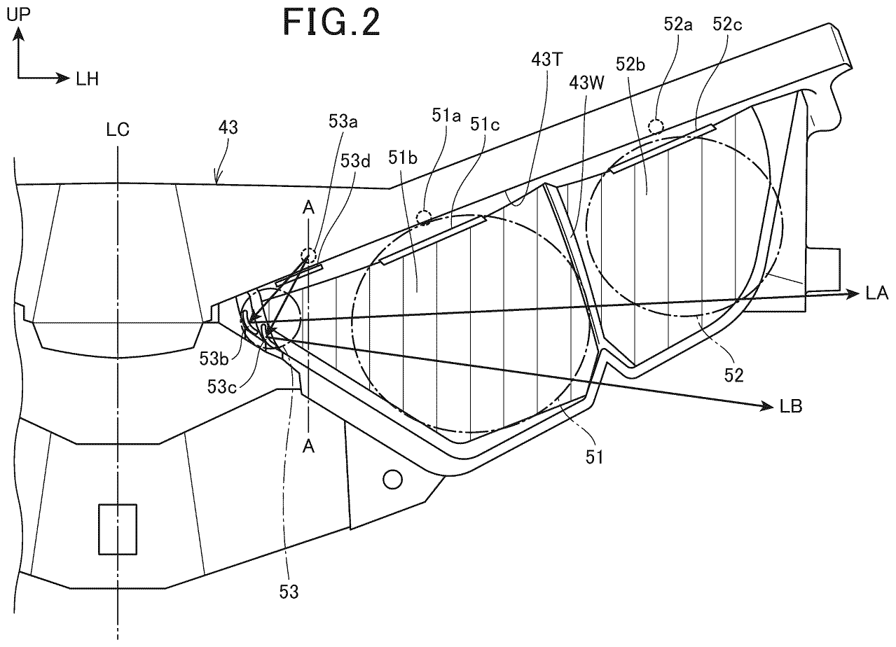

FIG. 2 shows, from the front, a state where the front surface cover 42 is removed from the light unit 41. Reference sign LC in FIG. 2 indicates the center of the vehicle width.

As shown in FIG. 2, the light unit 41 includes a housing 43 (also referred to as an enclosure) extending outward to the left and right via the vehicle width center LC. The housing 43 includes a pair of left and right low beam irradiators 51, a pair of left and right high beam irradiators 52, and a pair of left and right light irradiators 53. A range surrounded with a dotted chain line in FIG. 2 schematically shows a range in which respective irradiators 51 to 53 emit light. Emitting light means that the light emanates from the vehicle body.

The light unit 41 including the housing 43 and the respective irradiators 51 to 53 is symmetrical via the vehicle width center LC. Components constituting the low beam irradiators 51, the high beam irradiators 52 and the light irradiators 53 are housed in the housing 43.

The pair of left and right low beam irradiators 51 are provided spaced apart on the left and right sides. Each low beam irradiator 51 includes a low beam light source 51a and a low beam reflector 51b that reflects light from the low beam light source 51a to emit a low beam. The low beam light source 51a is a known light source such as an LED and emits visible light. The low beam reflector 51b is formed in a reflecting mirror that diffuses and reflects light from the low beam light source 51a toward the front of the vehicle and achieves forward illumination required for low beams (so-called passing headlight).

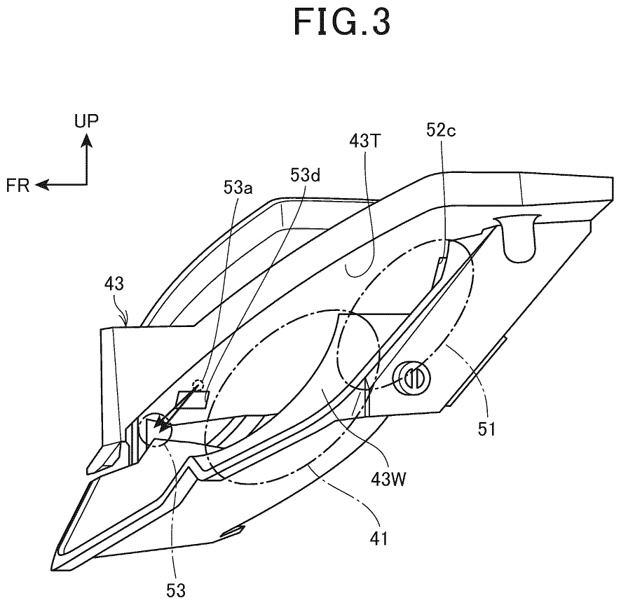

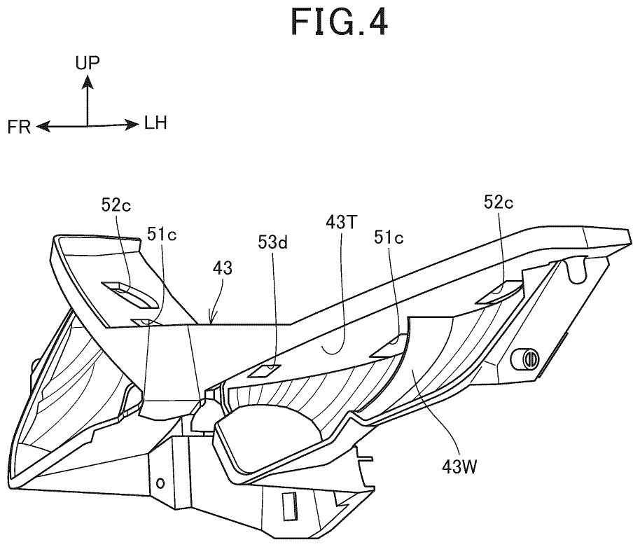

FIG. 3 is a left side view of the housing 43, and FIG. 4 is a perspective view of the housing 43.

As shown in FIG. 3, the pair of left and right high beam irradiators 52 are provided outward from the pair of left and right low beam irradiators 51 in the left-right direction and behind the low beam irradiators. As shown in FIG. 2, each high beam irradiator 52 includes a high beam light source 52a and a high beam reflector 52b that reflects light from the high beam light source 52a to emit a high beam. The high beam light source 52a is a known light source such as an LED and emits visible light. The high beam reflector 52b is formed in a reflecting mirror that diffuses and reflects the light from the high beam light source 52a toward the front of the vehicle and achieves forward illumination required for high beams (so-called traveling headlight).

The housing 43 integrally includes a ceiling part 43T extending above the low beam reflector 51b and the high beam reflector 52b, the ceiling part extending forward of the respective reflectors 51b and 52b (see FIGS. 3 and 4). The ceiling part 43T includes a low beam opening 51c (see FIG. 4) that is open toward the low beam reflector 51b, and a high beam opening 52c (see FIG. 4) that is open toward the high beam reflector 52b.

As shown in FIG. 2, the low beam light source 51a is located above the low beam opening 51c (corresponding to the opposite side of the low beam reflector 51b relative to the low beam opening 51c). For the light from the low beam light source 51a, light that passes through the low beam opening 51c is reflected by the low beam reflector 51b.

The high beam light source 52a is located above the high beam opening 52c (corresponding to the opposite side of the high beam reflector 52b relative to the high beam opening 52c). For the light from the high beam light source 52a, the light that passes through the high beam opening 52c is reflected by the high beam reflector 52b. Light incident on the respective reflectors 51b and 52b is adjusted through the low beam opening 51c and the high beam opening 52c.

Furthermore, a partition wall 43W is provided between the low beam reflector 51b and the high beam reflector 52b, and the partition wall 43W separates the low beam irradiator 51 and the high beam irradiator 52. The partition wall 43W adjusts the incidence of light from the low beam light source 51a onto the high beam reflector 52b and adjusts the incidence of light from the high beam light source 52a onto the low beam reflector 51b.

The pair of left and right light irradiators 53 are portions for emitting light beams LA and LB for improving the visibility of the saddle-ride vehicle 10 from others outside the vehicle. The light beam LA and LB adopt light having a small divergence angle such as parallel light and quasi-parallel light and can provide a higher brightness than low-beam or high-beam headlight light, which is generally diffusion light, at a predetermined position spaced away from the saddle-ride vehicle 10. This can ensure the distinguishability of the light beams LA and LB from the headlight light. This allows others present in a direction irradiated with the light beams LA and LB to easily recognize the light beams LA and LB and allows others outside the vehicle to notice the presence of the saddle-ride vehicle 10.

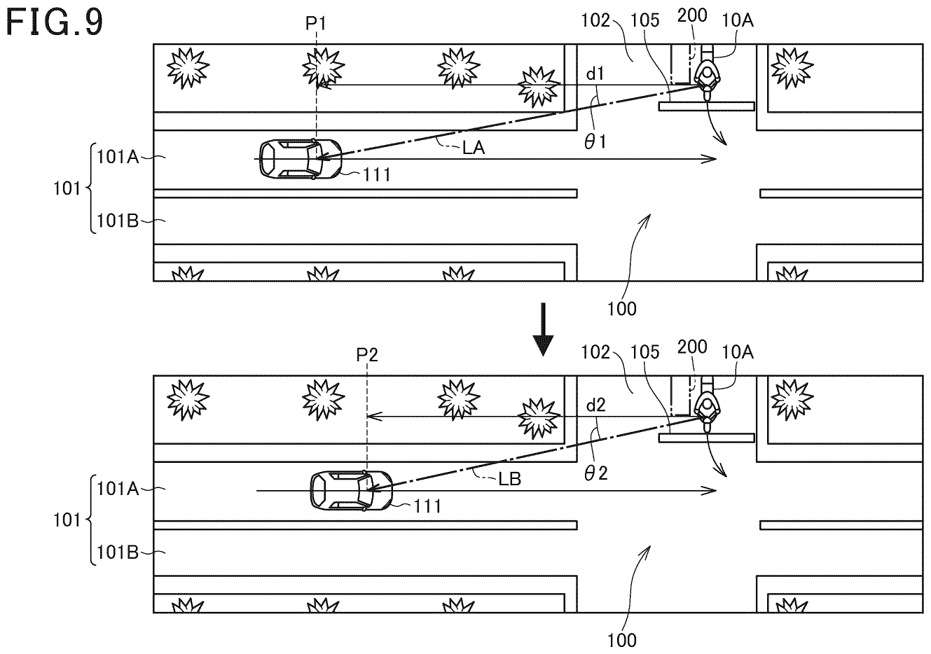

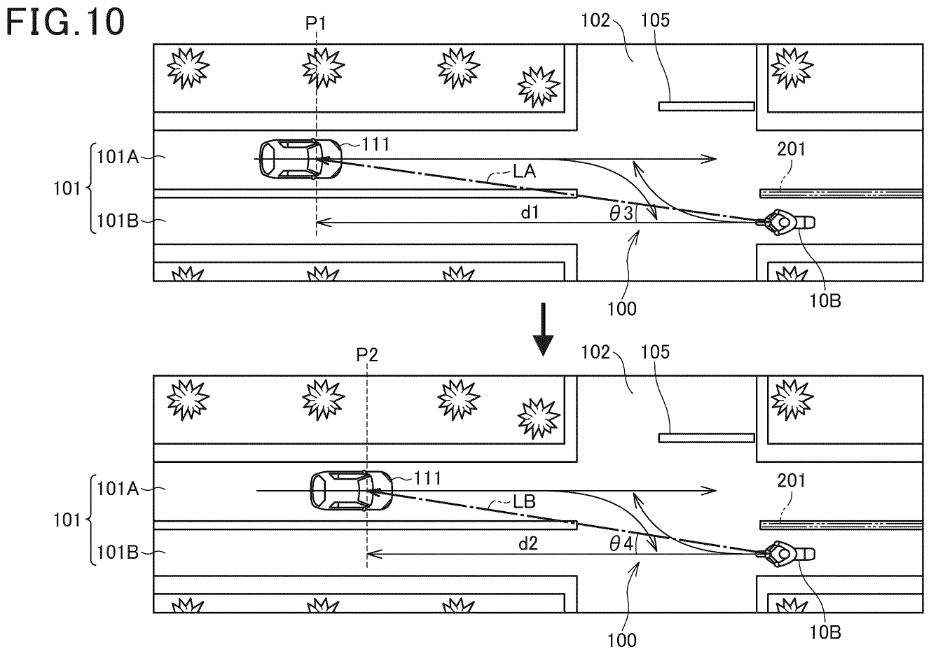

Here, the predetermined position is a position in a direction that is irradiated with the light beams LA and LB and may be a position farther than the headlight light or a position spaced away from an irradiation range with the headlight light. The predetermined position includes positions P1 and P2 (FIGS. 9 and 10) of another vehicle 111 as described later relative to the saddle-ride vehicle 10. The light beam LA and LB corresponds to the “predetermined light” of the present invention, and hereinafter, when the light beams LA and LB are particularly distinguished, the light beams are denoted as a first light beam LA and a second light beam LB.

As shown in FIGS. 2 and 3, the pair of left and right light irradiators 53 are provided inward from the pair of left and right low beam irradiators 51 in the left-right direction and outward and forward of the low beam irradiators. Each light irradiator 53 includes a first light source 53a, a first reflector 53b that reflects light from the first light source 53a to emit the first light beam LA, and a second reflector 53c that reflects light from the first light source 53a to emit the second light beam LB. The first light source 53a is a known light source such as an LED and emits visible light.

The first light source 53a is a light source located on an innermost side in the vehicle width direction and located most forward and downward among a plurality of light sources 51a, 52a, and 53a included in the light unit 41. These light sources 51a, 52a, and 53a are located forward of the handlebar 21a and the vehicle body frame 11.

These light sources 51a, 52a, and 53a are not limited to point light sources, and may be planar light sources in which a plurality of light emitting elements are densely arranged to radiate planar light. Each planar light source is, for example, a Chips on Board (COB) or Surface Mount Device (SMD) LED.

The first reflector 53b and the second reflector 53c are located in front of and below the plurality of light sources 51a, 52a, 53a and the other reflectors 51b, 52b, are supported on the housing 43, and are therefore arranged forward of left and right headlight light sources comprising the low beam light source 51a and the high beam light source 52a and between the left headlight light source and the right headlight light source.

As shown in FIG. 2, the ceiling part 43T of the housing 43 includes a first opening 53d that is open in the up-down direction below the first light source 53a and above the first reflector 53b and the second reflector 53c. As shown in FIG. 3, the first opening 53d is located behind the light irradiator 53 including the first reflector 53b and the second reflector 53c.

For the light from the first light source 53a, light that passes through the first opening 53d is reflected by the first reflector 53b and the second reflector 53c.

In the present configuration, the first opening 53d restricts the light incident from the first light source 53a into the light unit 41.

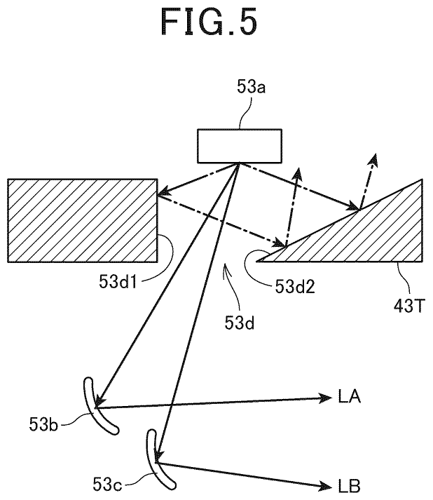

FIG. 5 is a view schematically showing an example of the shape of the first opening 53d and corresponds to an A-A cross section of FIG. 2.

As shown in FIG. 5, the first opening 53d is formed in a through hole having a trapezoidal cross section in a side cross-sectional view (a cross-sectional view cut along a plane extending in an axial direction in the first opening 53d). One inner surface 53d1 (in the present embodiment, the front inner surface) of front and rear inner surfaces of the first opening 53d is formed on a surface extending in a vertical direction, and the other inner surface 53d2 (the rear inner surface in the present embodiment) is formed in an inclined surface, which is oblique to the vertical direction and due to which an aperture in the first opening 53d narrows as the distance from the first light source 53a increases.

As shown in FIG. 5, for direct light from the first light source 53a, direct beams toward the respective reflectors 53b and 53c pass through the first opening 53d to enter the reflectors 53b and 53c and are reflected by the reflectors 53b and 53c, respectively.

In contrast, part of the light incident on the inner surface 53d1 extending perpendicularly from the first light source 53a is reflected by the inner surface 53d1 to enter the other inner surface 53d2. The other inner surface 53d2 reflects upward the light reflected by the other inner surface 53d2. Furthermore, the other inner surface 53d2 reflects upward the light incident from the first light source 53a. This suppresses a situation where light entering neither the first reflector 53b nor the second reflector 53c enters the light unit 41.

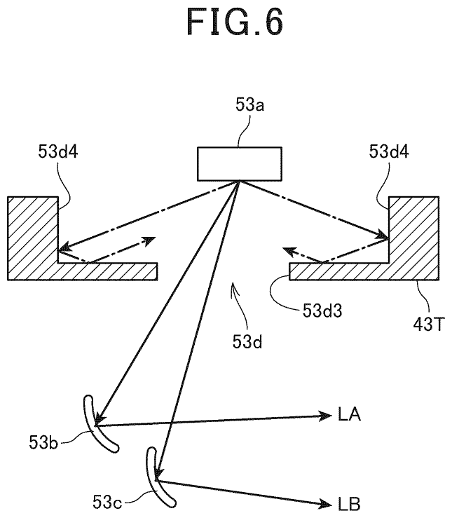

FIG. 6 is a view schematically showing another example of the shape of the first opening 53d. FIG. 6 corresponds to the A-A cross-section of FIG. 2.

As shown in FIG. 6, the first opening 53d is narrowed to a small-diameter through hole 53d3 through which direct beams of direct light from the first light source 53a pass toward the reflectors 53b and 53c, to prevent a situation where light entering neither the first reflector 53b nor the second reflector 53c enters the light unit 41.

Furthermore, a hole on a first light source 53a side in the first opening 53d is formed in a large-diameter through hole 53d4 continuous with the small-diameter through hole 53d3, and accordingly, the inner surface of the large-diameter through hole 53d4 is used to efficiently reflect light incident from the first light source 53a to outside the light unit 41.

The first reflector 53b is formed in a reflecting mirror that emits light from the first light source 53a in a predetermined direction. This direction is set in a direction suitable for improving the visibility of the saddle-ride vehicle 10 from outside the vehicle.

Furthermore, the first reflector 53b is disposed closer to the first light source 53a or away from the first light source 53a, and accordingly, an irradiation angle range of the first light beam LA can be changed. Changing the irradiation angle range can result in change in a cross-sectional area having a brightness equal to or higher than a predetermined brightness of the first light beam LA.

For example, when the first light beam LA is to be perceived by others only for a short period of time, or when it is important to allow others in a distant area to perceive the first light beam LA, the position of the first reflector 53b or the like is preferably set to narrow the irradiation angle range. Furthermore, when it is important to allow others located in a comparatively wide range or nearby to perceive the light beam LA, it is preferable to set the position of the first reflector 53b or the like to expand the irradiation angle range. Furthermore, the irradiation angle range may be changed by changing the shape of the first reflector 53b.

Furthermore, when the first light beam LA is reflected to emit parallel light by the first reflector 53b, as the first reflector 53b, a reflecting mirror may be adopted in which a region capable of emitting the light beam LA having a predetermined width in a desired direction is formed on a reflecting surface in a circular paraboloid focusing on the position of the first light source 53a.

In addition, when the first light beam LA is reflected to emit quasi-parallel light, for example, the reflecting surface of the first reflector 53b may be a reflecting surface that approximates the circular paraboloid. The quasi-parallel light is divergent light in a state close to parallel light. The quasi-parallel light has a small divergence angle and can be emitted as light having a brightness equal to or higher than a certain level over a comparatively far distance in the same manner as parallel light.

The second reflector 53c is formed in a reflecting mirror that emits light from the first light source 53a in a predetermined direction. This direction is set in a direction that faces another person (person to be irradiated) to improve the visibility of the saddle-ride vehicle 10.

As in the case of the first reflector 53b, by adjusting the position of or changing the shape of the second reflector 53c, the irradiation angle range of the second light beam LB can be changed, the cross-sectional area of the second light beam LB (corresponding to a cross-sectional area having a brightness equal to or higher than a predetermined brightness (for example, illuminance or luminance recognizable by others) ) can be increased or decreased, and the second light beam LB can be reflected to emit parallel light, quasi-parallel light, or the like.

Furthermore, FIG. 2 shows that one first light source 53a is provided for the light beams LA and LB, and a light source may be provided for each of the light beams LA and LB. When the light source is provided for each of the light beams LA and LB, the luminance and illuminance of the light beams LA and LB can be easily changed.

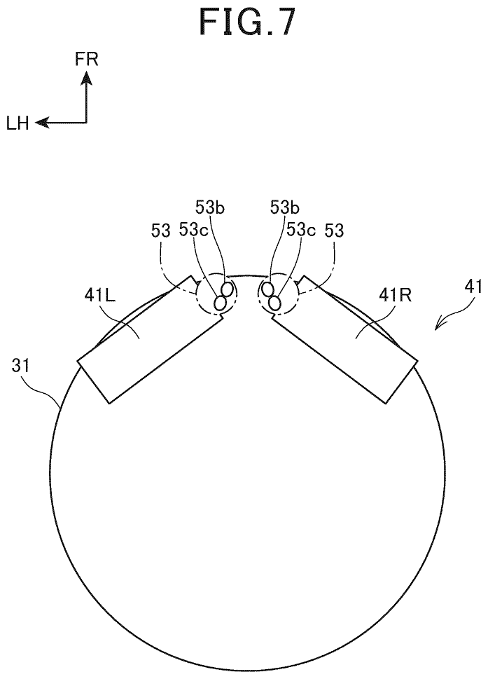

FIG. 7 is a view schematically showing the pair of left and right light irradiators 53 together with a peripheral configuration in vehicle top view. FIG. 7 shows the light unit 41 comprising a left headlight light irradiator 41L including the low beam irradiator 51 and the high beam irradiator 52 on the left side, and a right headlight light irradiator 41R including the low beam irradiator 51 and the high beam irradiator 52 on the right side.

As shown in FIG. 7, the front surface of the light unit 41 including a pair of left and right headlight light irradiators 41L and 41R has an inclined shape that narrows in the vehicle width direction as being further forward in the vehicle.

Next, the light beams LA and LB will be described.

As described above, the light beams LA and LB are light capable of providing a higher brightness than the headlight light, which is diffusion light, in the direction in which the respective light beams LA and LB are emitted.

The light beams LA and LB will be described in relation to a traveling situation.

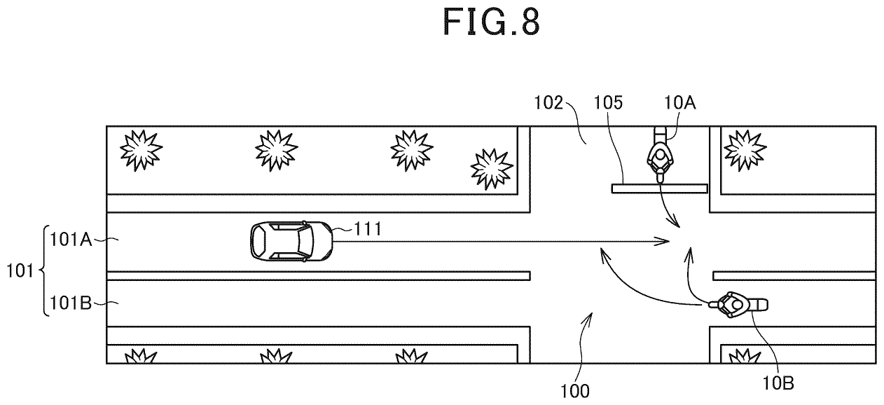

FIG. 8 is a view showing, from above, the traveling situation in which vehicles are traveling.

FIG. 8 shows an intersection (also referred to a crossroad) 100 where two roads intersect, together with surroundings, and a road including a lane 101A where another vehicle 111 (hereinafter denoted as “the other vehicle 111″) travels is referred to as “first road 101”, while a road intersecting the first road 101 is denoted as “second road 102”.

As the saddle-ride vehicle 10 of the present embodiment, vehicles 10A and 10B each comprising a motorcycle located at the intersection 100 are illustrated. The vehicle 10A is a vehicle located on the second road 102 and is about to turn left into the lane 101A of the first road 101 (the lane along which the other vehicle 111 travels). The vehicle 10B is a vehicle located on an opposite lane (also referred to as an oncoming road) 101B to the lane 101A, in which the other vehicle 111 travels, and is about to make a U-turn at the intersection 100 or to turn right on the second road 102. Reference numeral 105 in FIG. 8 denotes a stop line on which the vehicle 10A stops.

FIG. 9 is a view showing, from above, the vehicle 10A together with the other vehicle 111.

As shown in FIG. 9, the vehicle 10A emits the light beams LA and LB in respective directions at angles θ1 and θ2 corresponding to directions toward the side at the front of the vehicle.

The angle θ1 indicates the direction in which the first light beam LA is emitted toward a driver of the other vehicle 111 when the other vehicle 111 is at the position P1 on the lane 101A, and FIG. 9 illustrates that the direction is from the vehicle 10A toward the side at the front of the vehicle. The angle θ2 indicates the direction in which the second light beam LB is emitted toward the driver of the other vehicle 111, while the other vehicle 111 is at the position P2 on the lane 101A. FIG. 9 illustrates that the direction is from the vehicle 10A toward the side at the front of the vehicle. The other vehicle 111 is a vehicle that may possibly become a vehicle following the vehicle 10A after the vehicle 10A turns left.

As shown in FIG. 9, the position P2 corresponds to a position closer to the vehicle 10A in the vehicle width direction than the position P1.

The positions P1 and P2 each are set to a position suitable for the other vehicle 111 to avoid contact with the vehicle 10A based on simulations and experiments.

For example, the positions P1 and P2 are set to a position where the other vehicle 111 can avoid the vehicle 10A without contacting the vehicle 10A or a position where the vehicle 111 can stop. Furthermore, the position P1 is the position of the other vehicle 111 before reaching the position P2. When the position P1 is defined as a separation distance d1 from the vehicle 10A, and the position P2 is defined as a separation distance d2 from the vehicle 10A, the separation distance d1>the separation distance d2.

By emitting the light beams LA and LB from the vehicle 10A in the respective directions at the angles θ1 and θ2, the first light beam LA is emitted toward the position P1, and the second light beam LB is emitted toward the position P2. Consequently, the light beams LA and LB can be emitted toward the driver of the other vehicle 111 that may possibly become a following vehicle, allowing the driver of the other vehicle 111 to notice the presence of the vehicle 10A.

Furthermore, the light beams LA and LB are emitted forward of the steering handlebar 21a (see FIG. 1), so that the light beams LA and LB are not blocked by the rider located behind the handlebar 21a, that is, the rider of the vehicle 10A.

Additionally, in the example of FIG. 9, since it is possible to allow the driver of the other vehicle 111 to perceive the light beams LA and LB at different positions P1 and P2, the light beams LA and LB can be recognized by the driver of the other vehicle 111 at a time interval. Consequently, the light beams LA and LB allow the driver of the other vehicle 111 to perceive light such as flashing and allow the driver of the other vehicle 111 to easily recognize the vehicle 10A.

In the present configuration, as shown in FIG. 3, the light irradiators 53 that emit the light beams LA and LB are provided at a vehicle forward position in the vehicle 10A. The vehicle 10A is a traveling vehicle, and there is usually no obstacle forward to a traveling destination. As illustrated in FIG. 9, however, there may be an obstacle 200 to the side of the vehicle 10A.

It is assumed that the obstacle 200 in FIG. 9 is another saddle-ride vehicle located to the right of the vehicle 10A. The obstacle 200 is not limited to the vehicle, and may be a fence or plant located to the left of the vehicle 10A. There may be an obstacle to the right of the vehicle 10A depending on the road and surrounding environments.

In the present configuration, the light beams LA and LB are emitted from a vehicle forward position in the vehicle 10A, and hence the light beams LA and LB are easily emitted without being blocked by the obstacle 200 to the side of the vehicle 10A as illustrated in FIG. 9, even if obstacles 200 exist to the left and right of the vehicle 10A, as compared with a case where the beams LA and LB are emitted from a vehicle rearward position in the vehicle 10A. Even if the obstacle 200 exists at a position that blocks the light beam LA, the light beam LB is emitted more forward than the light beam LA, so that the light beam LB is easily emitted without being blocked by the obstacle 200. Furthermore, it is possible to emit the light beams LA and LB from a position closer to the other vehicle 111, as compared with a case where the light beams LA and LB are emitted from the vehicle rearward position in the vehicle 10A.

That is, due to a positional relation between the position of an own vehicle comprising the vehicle 10A and the obstacle 200 to the side of the own vehicle, the beams LA and LB are less likely to be blocked by the obstacle 200. Consequently, even if the obstacle 200 exists, the light beams LA and LB allow the driver of the other vehicle 111 to easily notice the presence of the vehicle 10A.

FIG. 10 is a view showing, from above, the vehicle 10B together with the other vehicle 111.

As shown in FIG. 10, the vehicle 10B emits light beams LA and LB in respective directions at angles θ3 and θ4 corresponding to directions toward the side at the front of the vehicle.

The angle θ3 indicates the direction in which the first light beam LA is emitted toward the driver of the other vehicle 111 when the other vehicle 111 is at a position P1 on a lane 101A. The angle θ4 indicates the direction in which the second light beam LB is emitted toward the driver of the other vehicle 111, when the other vehicle 111 is at a position P2 on the lane 101A. The other vehicle 111 is an oncoming vehicle to the vehicle 10B.

As shown in FIG. 10, the position P2 corresponds to a position closer to the vehicle 10B than the position P1 in a vehicle front-rear direction.

The positions P1 and P2 each are set to a position suitable for the other vehicle 111 to avoid contact with the vehicle 10B based on simulations and experiments. For example, the positions P1 and P2 each are set to a position where the other vehicle 111 can avoid the vehicle 10B without contacting the vehicle 10B or a position where the vehicle 111 can stop. As in the case of FIG. 9, the position P1 is the position of the other vehicle 111 before reaching the position P2. When the position P1 is defined as a separation distance d1 from the vehicle 10B and the position P2 is defined as a separation distance d2 from the vehicle 10B, the separation distance d1>the separation distance d2.

Therefore, when the vehicle 10B emits the beams LA and LB in respective directions at the angles θ3 and θ4, the first light beam LA is emitted toward the position P1, and the second light beam LB is emitted toward the position P2. Consequently, the beams LA and LB can be emitted toward the driver of the other vehicle 111 that is the oncoming vehicle and can allow the driver of the other vehicle 111 to easily notice the presence of the vehicle 10A.

Furthermore, the light beams LA and LB are emitted forward of the steering handlebar 21a (see FIG. 1), and accordingly, the beams LA and LB are not blocked by a rider located behind the handlebar 21a, that is, the rider of the vehicle 10B.

Additionally, in the example of FIG. 10, since the driver of the other vehicle 111 can perceive the light beams LA and LB at distinct positions P1 and P2, the light beams LA and LB can be recognized by the driver of the other vehicle 111 at a time interval. Consequently, the light beams LA and LB can allow the driver of the other vehicle 111 to perceive light as flashing, allowing the driver of the other vehicle 111 to easily notice the presence of the vehicle 10A.

Furthermore, in the present configuration, as shown in FIG. 3, the light irradiator 53 that emits the light beams LA and LB is provided at a vehicle forward position in the vehicle 10B. Therefore, as shown in FIG. 10, even if an obstacle 201 (for example, a fence or plant) that blocks light exists to the side of the vehicle 10B, the light irradiator 53 easily emits light beams LA and LB without being blocked by the obstacle 201 and can easily emit the light beams LA and LB from a position closer to the other vehicle 111. That is, the light beams LA and LB are less likely to be blocked by the obstacle 201 due to a positional relation between the position of the own vehicle comprising the vehicle 10B and the obstacle 201 to the side of the own vehicle. Consequently, the light beams LA and LB allow the driver of the other vehicle 111 to notice the presence of the vehicle 10B.

As shown in FIGS. 9 and 10, the first light beam LA is light that reaches the driver of the other vehicle 111 that is relatively distant from the own vehicle comprising the vehicle 10A or 10B, and the second light beam LB is light that reaches the driver of the other vehicle 111 that is relatively close. Therefore, the first light beam LA may be denoted as “light reaching a distant area from the vehicle”, and the second light beam LB may be denoted as “light reaching the vicinity of the vehicle”. Furthermore, the second light beam LB is light that reaches closer to the vehicle width center of the vehicle 10A or 10B than the first light beam LA.

Furthermore, when the position P1 shown in FIGS. 9 and 10 is denoted as “the first position”, the position P2 may be denoted as “the second position that is closer to the own vehicle that is the saddle-ride vehicle 10 than the first position in the vehicle front-rear direction or the vehicle width direction”.

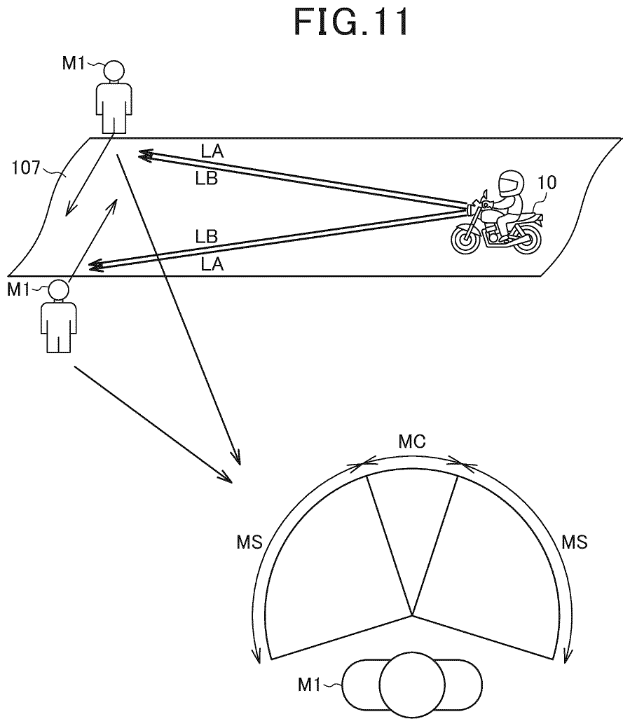

FIG. 11 shows a situation where pedestrians MI exist on left and right sides forward of a traveling saddle-ride vehicle 10. It is assumed that the pedestrians M1 face a road 107 on which the saddle-ride vehicle 10 travels.

As shown in FIG. 11, the light irradiators 53 emit light beams LA and LB toward the side at the front of the vehicle and therefore allow the pedestrians M1 present on the left and right sides forward of the vehicle 10 to notice the presence of the saddle-ride vehicle 10. Therefore, not only the occupant of the other vehicle 111 but also the pedestrians M1 around the saddle-ride vehicle 10 can easily recognize the saddle-ride vehicle 10.

FIG. 11 schematically shows a central visual field MC and a peripheral visual field MS of a person (pedestrian M1). The central visual field MC is a range that can be seen without moving eyeballs, and the peripheral visual field MS is a visual field outside the central visual field MC. For human visual features, it is known that with the central visual field MC, the shape of a surrounding object can be clearly distinguished, while response to the movement of the object tends to be relatively delayed. In addition, it is known that with the peripheral visual field MS, the shape of the surrounding object cannot be clearly distinguished, while the response to the movement of the object tends to be relatively quick.

In the present configuration, in the case of the arrangement of the saddle-ride vehicle 10 and the pedestrians M1 as shown in FIG. 11, the saddle-ride vehicle 10 can emit the light beams LA and LB toward the peripheral visual fields MS of the pedestrians M1. Consequently, an effect of allowing the pedestrians M1 to easily recognize the saddle-ride vehicle 10 can be expected.

As described above, the light unit 41 constituting the lighting device emits the light beams LA and LB as predetermined light capable of providing a higher brightness than the headlight light of the own vehicle at the positions P1 and P2, the positions being predetermined positions spaced away from the own vehicle that is the saddle-ride vehicle 10, the light beams LA and LB being emitted from a position forward of the center of the vehicle in the front-rear direction.

The light beams LA and LB capable of providing a higher brightness than the headlight light of the own vehicle are emitted at the positions P1 and P2 spaced away from the own vehicle, so that others present at the positions P1 and P2 can easily perceive the light beams LA and LB. Additionally, since the light beams LA and LB are emitted from the position forward of the center of the vehicle in the front-rear direction, the light beams LA and LB are less likely to be blocked due to a positional relation between the position of the own vehicle and the obstacle to the side of the own vehicle (obstacles 200 and 201 shown in FIGS. 9 and 10).

Therefore, the light beams LA and LB are easily emitted toward the front of the obstacle. Furthermore, light can be emitted from a position closer to others at the positions P1 and P2 spaced away in a traveling direction. Therefore, even if there is an obstacle to the side of the vehicle, the light beams LA and LB allow others to easily recognize the saddle-ride vehicle 10.

Furthermore, the saddle-ride vehicle 10 includes the steering handlebar 21a, and the light beams LA and LB are emitted from the position forward of the handlebar 21a. Since the light beams LA and LB are emitted from the position forward of the handlebar 21a, the light beams LA and LB are not blocked by the rider located behind the handlebar 21a, that is, the rider of the saddle-ride vehicle 10. Since the rider does not block the light beams LA and LB, the light beams LA and LB are easily perceived by others present at the positions P1 and P2 and therefore allow others to easily recognize the saddle-ride vehicle 10. Furthermore, since the light beams LA and LB are emitted from the position forward of the handlebar 21a, the light beams LA and LB are less likely to be blocked by the obstacle due to the positional relation between the position of the own vehicle comprising the saddle-ride vehicle 10 and the obstacle to the side of own vehicle. Therefore, it is easier to emit the light beams LA and LB toward the front of the obstacle. Therefore, even if there is an obstacle to the side of the handlebar 21a, the light beams LA and LB allow others to easily recognize the saddle-ride vehicle 10.

In addition, the saddle-ride vehicle 10 of the present embodiment includes a so-called frame mount structure in which the light unit 41 is supported on the vehicle body frame 11, and may instead include a so-called handle mount structure in which the light unit 41 is supported on a steering system including the front fork 14 and the like and in which the light unit 41 changes direction to the left or right depending on steering of the handle 21.

When the handle mount structure is used, the direction of the light beams LA and LB changes according to the movement and steering angle of the handle 21, so that an effect of emitting the light beams LA and LB in a direction allowing others to easily notice can be expected.

Furthermore, the configuration in which the light beams LA and LB emanate from forward of the steering handlebar 21a and the vehicle body frame 11 is combined with the handle mount structure of the light unit 41, and accordingly, the light beams LA and LB can be emitted from the position closer to others while increasing a possibility of emitting the light beams LA and LB in such a direction that the light beams are not blocked by obstacles, so that an effect of allowing others to easily recognize the vehicle 10A can be expected.

In addition, as shown in FIG. 2, the light unit 41 includes a plurality of light sources 51a, 52a and 53a arranged to be displaced in the front-rear direction of the vehicle, and the first reflector 53b and the second reflector 53c that reflect light from either one of the respective light sources 51a, 52a, and 53a to emit the light beams LA and LB. These reflectors 53b and 53c are arranged forward of the light sources 51a, 52a, and 53a.

Since the first reflector 53b and the second reflector 53c are arranged forward of the plurality of light sources 51a, 52a, and 53a included in the light unit 41, the light beams LA and LB can be emitted forward of the light sources 51a, 52a, and 53a. Consequently, the light beams LA and LB are less likely to be blocked by the obstacle due to the positional relation between the position of the own vehicle comprising the saddle-ride vehicle 10 and the obstacle to the side of the own vehicle. Therefore, even if there is an obstacle to the side of the light sources 51a, 52a, and 53a, it is easier to emit the light beam LA and LB toward the front of the obstacle. The light beams LA and LB allow others to easily recognize the saddle-ride vehicle 10.

Furthermore, as shown in FIG. 7, the light unit 41 includes left and right headlight light sources comprising the low beam light source 51a and the high beam light source 52a. The front surface of the light unit 41 has the inclined shape that narrows in the vehicle width direction as being further forward in the vehicle, and the reflectors 53b and 53c are arranged forward of the headlight light sources and between the left headlight light source and the right headlight light source.

The front surface of the light unit 41 has the inclined shape that narrows in the vehicle width direction as being further forward in the vehicle, and the reflectors 53b and 53c are arranged forward of the left and right headlight light sources. Therefore, the reflectors 53b and 53c can emit the light beams LA and LB from forward of the headlight light irradiators 41L and 41R. The light beams LA and LB are less likely to be blocked by the obstacle due to the positional relation between the position of the own vehicle comprising the saddle-ride vehicle 10 and the obstacle to the side of the vehicle. Therefore, even if there is an obstacle to the side of the headlight light source, it is easier to emit the light beams LA and LB toward the front of the obstacle, and the light beams LA and LB allow others to easily recognize the saddle-ride vehicle 10.

Furthermore, the reflectors 53b and 53c can be arranged forward of the headlight light sources by using a space made between the left headlight light source and the right headlight light source.

### Other Embodiments

A saddle-ride vehicle 10 according to another embodiment includes the same configuration as the above embodiment except that the vehicle includes a cover 45 that covers a region between a left headlight light irradiator 41L and a right headlight light irradiator 41R from the front. Hereinafter, parts different from the above embodiment will be described, the same configuration as the above embodiment is denoted with the same reference signs, and parts overlapping with the above embodiment will not be described.

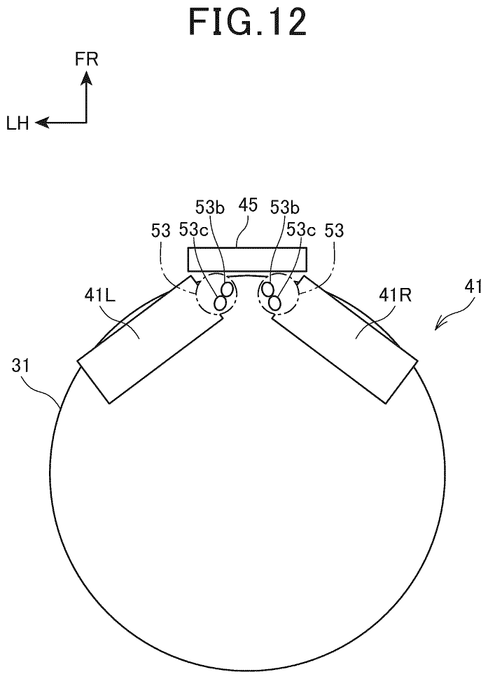

FIG. 12 is a view schematically showing a pair of left and right light irradiators 53 together with a peripheral configuration in vehicle top view.

As shown in FIG. 12, the cover 45 is disposed to cover the region between the left headlight light irradiator 41L and the right headlight light irradiator 41R from the front. The cover 45 may be a part of a front surface cover 42 that covers the front surface of a housing 43 or may be a cover different from the front surface cover 42.

The saddle-ride vehicle 10 is configured to include the pair of left and right light irradiators 53 between the left headlight light irradiator 41L and the right headlight light irradiator 41R that constitute the pair, and more specifically, include a plurality of reflectors 53b and 53c between the left headlight light irradiator 41L and the right headlight light irradiator 41R that constitute the pair, so that the cover 45 can prevent the respective reflectors 53b and 53c from being easily recognized from the front of the vehicle or the like.

It may be considered that the cover 45 is a cover that covers a part of a light unit 41 comprising a lighting device, and a cover that covers between so-called twin-lens headlight light irradiators 41L and 41R including the pair of left and right headlight light irradiators 41L and 41R. At least a part of the cover 45 is located forward of the respective reflectors 53b and 53c and overlaps the respective reflectors 53b and 53c in vehicle front view, which makes it difficult to visually recognize the respective reflectors 53b and 53c from outside the vehicle and is advantageous in improving appearance.

Thus, the saddle-ride vehicle 10 according to the other embodiment includes the cover 45 that covers a part of the light unit 41, and a part of the cover 45 is located forward of the reflectors 53b and 53c and overlaps the reflectors 53b and 53c in vehicle front view. Consequently, the use of the cover 45 makes it difficult to visually recognize the respective reflectors 53b and 53c from outside the vehicle and is advantageous in improving the appearance.

Note that the cover 45 may be an extension provided in the light unit 41.

Each of the above-described embodiments is merely an illustration of one aspect of the present invention and can be arbitrarily modified and applied to such an extent that does not depart from the spirit of the present invention.

For example, in each of the above-described embodiments, the case of applying the present invention to the so-called twin-lens saddle-ride vehicle 10 including the pair of left and right headlight light irradiators 41L and 41R has been described but is not limited thereto. For example, the present invention may be applied to a so-called single-lens saddle-ride vehicle including one headlight light irradiator.

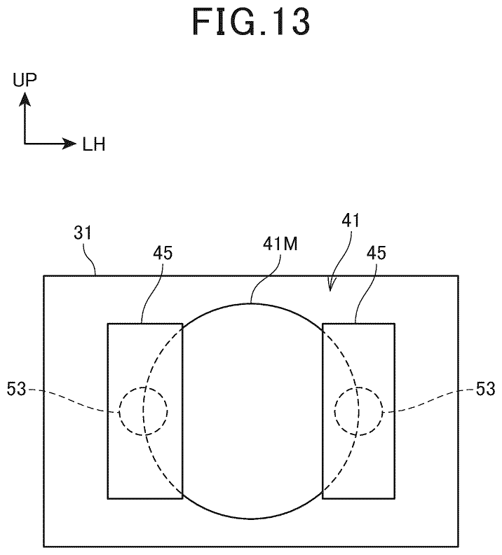

FIG. 13 is a view schematically showing a headlight light irradiator 41M of the single-lens saddle-ride vehicle together with a peripheral configuration in vehicle front view.

The example of FIG. 13 includes a configuration in which light irradiators 53 including reflectors 53b and 53c are arranged on the left and right sides of the headlight light irradiator 41M, respectively, and light beam LA and LB emanate from a region of the light irradiators 53. Furthermore, the configuration includes a pair of left and right covers 45 that cover a part of the light unit 41 on the left and right sides of the headlight light irradiator 41M. In this case, a pair of left and right light irradiators 53 are arranged at a position behind the pair of left and right covers 45, the position overlapping each cover 45 in vehicle side view. Consequently, the pair of left and right covers 45 can make it difficult to visually recognize the respective reflectors 53b and 53c from outside the vehicle and are advantageous in improving appearance.

In addition, the position of each light irradiator 53 may be changed as necessary, and the light irradiator 53 may be provided, for example, outside the light unit 41. However, from a viewpoint of preventing the light irradiators from being obstructed by obstacles to the side of the vehicle, the position of the light irradiator 53 is preferably within a range where the light beams LA and LB can emanate forward from the center of the vehicle in the front-rear direction, and from a viewpoint of preventing the light irradiators 53 from being obstructed by the rider as well as the obstacles to the side of the vehicle, the light irradiators 53 are preferably positioned forward of a handlebar 21a and a vehicle body frame 11.

Furthermore, a first light source 53a for light beams LA and LB is not limited to one source and may comprise a plurality of sources. Furthermore, the case where the first light source 53a is a dedicated light source for the light beams LA and LB has been described, and is not limited thereto, and either one of the light sources included in the saddle-ride vehicle 10 may be used concurrently as the first light source 53a.

The shape, position, and number of parts of the light unit 41 including the reflectors 53b and 53c may be changed as necessary.

In addition, the irradiation direction with the light beams LA and LB is not limited to the direction toward the side at the front of the vehicle and may only be a direction suitable for an occupant of the other vehicle as well as pedestrians to recognize the vehicle 10.

The case where the light irradiators 53 emit two light beams LA and LB in the direction toward the side at the front of the vehicle has been described, but is not limited thereto, and one or more light beams may be emitted.

In addition, the saddle-ride vehicle to which the present invention is applicable is not limited to the motorcycle, and the present invention may be applied to various saddle-ride vehicles including a three wheeled vehicle and a four wheeled vehicle.

### Configurations Supported by the Above Embodiments

The above embodiments support the following configurations.
(Configuration 1) A saddle-ride vehicle comprising: a lighting device, the lighting device emitting predetermined light capable of providing a higher brightness than headlight light of the vehicle at a predetermined position spaced away from the vehicle, the predetermined light being emitted from a position forward of the center of the vehicle in a front-rear direction.

Since the predetermined light capable of providing a higher brightness than the headlight light of the vehicle is emitted at the predetermined position spaced away from the vehicle, others present at the predetermined positions can easily perceive the predetermined light. Additionally, since the predetermined light is emitted from the position forward of the center of the vehicle in the front-rear direction, the predetermined light is less likely to be blocked due to a positional relation between the position of an own vehicle comprising the saddle-ride vehicle and an obstacle to the side of the own vehicle.

Therefore, it is easier to emit the predetermined light toward the front of the obstacle. Consequently, even if there is an obstacle to the side of the vehicle, the predetermined light allows others to easily recognize the saddle-ride vehicle.
(Configuration 2) The saddle-ride vehicle according to Configuration 1, further comprising a steering handlebar, wherein the predetermined light is emitted from a position forward of the handlebar.

Since the predetermined light is emitted from the position forward of the handlebar, the predetermined light is not blocked by a rider located behind the handlebar, that is, the rider of the saddle-ride vehicle. Since the predetermined light is not blocked by the rider, the predetermined light is easily perceived by others present at the predetermined position, so that others can easily recognize the saddle-ride vehicle. Furthermore, since the predetermined light is emitted from the position forward of the handlebar, the predetermined light is less likely to be blocked by the obstacle due to the positional relation between the position of the own vehicle comprising the saddle-ride vehicle and the obstacle to the side of own vehicle. Therefore, it is easier to emit the predetermined light toward the front of the obstacle. Therefore, even if there is an obstacle to the side of the handlebar, the predetermined light allows others to easily recognize the saddle-ride vehicle.
(Configuration 3) The saddle-ride vehicle according to Configuration 1 or 2, wherein the lighting device includes a plurality of light sources being arranged to be displaced in the front-rear direction of the vehicle, and a reflector that reflects light from either one of the plurality of light sources to emit the predetermined light, the reflector being disposed forward of the plurality of light sources.

Since the reflector is disposed forward of the plurality of light sources included in the lighting device, the predetermined light can be emitted forward of the plurality of light sources. Consequently, the predetermined light is less likely to be blocked by the obstacle due to the positional relation between the position of the own vehicle comprising the saddle-ride vehicle and the obstacle to the side of the own vehicle. Therefore, even if there is an obstacle to the side of the plurality of light sources, it is easier to emit the predetermined light toward the front of the obstacle, and the predetermined light allows others to easily recognize the saddle-ride vehicle.
(Configuration 4) The saddle-ride vehicle according to Configuration 3, further comprising: a cover that covers a part of the lighting device, wherein a part of the cover is located forward of the reflector and overlaps the reflector in vehicle front view.

A part of the cover that covers a part of the lighting device is located forward of the reflector and overlaps the reflector in vehicle front view, so that the use of the cover can prevent the reflector from being easily recognized from outside the vehicle and is advantageous in improving appearance.
(Configuration 5) The saddle-ride vehicle according to Configuration 3 or 4, wherein the lighting device includes left and right headlight light sources, the front surface of the lighting device has an inclined shape that narrows in a vehicle width direction as being further forward in the vehicle, and the reflector is disposed forward of the headlight light sources and between the left headlight light source and the right headlight light source.

The front surface of the lighting device has the inclined shape that narrows in the vehicle width direction as being further forward in the vehicle, and the reflector is disposed forward of the left and right headlight light sources and between the left headlight light source and the right headlight light source. Therefore, the reflector can emit the predetermined light forward of the left and right headlight light sources. The predetermined light is less likely to be blocked by the obstacle due to the positional relation between the position of the own vehicle comprising the saddle-ride vehicle and the obstacle to the side of the vehicle. Therefore, even if there is an obstacle to the side of the headlight light source, it is easier to emit the predetermined light toward the front of the obstacle, and the predetermined light allows others to easily recognize the saddle-ride vehicle. Furthermore, the reflector can be disposed forward of the headlight light sources by using a space made between the left headlight light source and the right headlight light source.

### REFERENCE SIGNS LIST

10 saddle-ride vehicle
10A, 10B vehicle (saddle-ride vehicle)
11 vehicle body frame
21 handle
21a handlebar
41 light unit (lighting device)
41L, 41R headlight light irradiator
45 cover
51 low beam irradiator
51a low beam light source (headlight light source)
52 high beam irradiator
52a high beam light source (headlight light source)
53 light irradiator
53a first light source
53b first reflector
53c second reflector
111 other vehicle
200, 201 obstacle
LA, LB light (predetermined light)
LC vehicle width center
P1 position (first position)
P2 position (second position)

1.-5. (canceled)

6. A saddle-ride vehicle comprising:
a lighting device, the lighting device emitting predetermined light capable of providing a higher brightness than headlight light of the vehicle at a predetermined position spaced away from the vehicle,
the predetermined light being emitted from a position forward of the center of the vehicle in a front-rear direction,
the lighting device including:
a plurality of light sources being arranged to be displaced in the front-rear direction of the vehicle, and
a reflector that reflects light from either one of the plurality of light sources to emit the predetermined light,
the plurality of light sources including left and right headlight light sources, wherein the front surface of the lighting device has an inclined shape that narrows in a vehicle width direction as being further forward in the vehicle, and
the reflector is disposed forward of the plurality of light sources including the headlight light sources and between the left headlight light source and the right headlight light source.

7. The saddle-ride vehicle according to claim 6, further comprising:
a steering handlebar, wherein the predetermined light is emitted from a position forward of the handlebar.

8. The saddle-ride vehicle according to claim 6, further comprising:
a cover that covers a part of the lighting device, wherein a part of the cover is located forward of the reflector and overlaps the reflector in vehicle front view.

9. The saddle-ride vehicle according to claim 7, further comprising:
a cover that covers a part of the lighting device, wherein a part of the cover is located forward of the reflector and overlaps the reflector in vehicle front view.
